(19) United States
(12) Patent Application Publication
(10) Pub. No.: US 2026/0205397 A1
(43) Pub. Date: Jul. 16, 2026

(54) METHOD, DEVICE, AND COMPUTER PROGRAM PRODUCT FOR MONITORING STATUS OF CONNECTION

(71) Applicant: DELL PRODUCTS L.P., ROUND ROCK, TX (US)

(72) Inventors: Shuguang GONG, Beijing (CN); Long WANG, Beijing (CN); Zhiping AN, Beijing (CN); Zonghuan XIAO, Shanghai (CN); Wenbo LI, Beijing (CN)

(21) Appl. No.: 19/065,238

(22) Filed: Feb. 27, 2025

(30) Foreign Application Priority Data
Jan. 10, 2025 (CN) 202510048796.6

(51) Int. Cl. H04L 43/0864; H04L 43/02

(52) U.S. Cl. CPC H04L 43/0864; H04L 43/02

(57) ABSTRACT

A method includes sending, based on a received user request, a capture task of a data packet associated with the user request to multiple nodes. The method further includes receiving the captured data packet from the multiple nodes. The method further includes determining information of a source end of the data packet, information of a target end of the data packet, and operation information of a connection between the source end and the target end. The method further includes monitoring the status of the connection based on at least one of the data packet, the information of the source end, the information of the target end, and the operation information. In this way, information of various communication endpoints and their connections within a node can be comprehensively captured, providing more detailed and accurate data.

### TECHNICAL FIELD

The present disclosure relates to the field of computers, and more specifically, to a method, a device, and a computer program product for monitoring status of a connection.

### BACKGROUND

A distributed database (DD) extended system is an important part in the field of modern information technologies, which can achieve scalability and high availability of the system by dispersing data storage on multiple nodes in the network. In the DD extended system, specific data processing tasks are typically executed through multiple services to support the operation of the entire system. Due to the direct impact of the efficiency and performance of inter-service communication on the overall response speed and user experience of the system, it is necessary to monitor and analyze the performance of inter-service communication.

There are some tracking tools that can track individual connections of data packets between services, and these tools can assist in diagnosing network problems or optimizing performance. Meanwhile, there are also some tools that can analyze the average delay between services and visualize the system topology, enabling a system administrator to intuitively identify interaction bottlenecks between services.

### SUMMARY OF THE INVENTION

Embodiments of the present disclosure provide a method, a device, and a computer program product for monitoring status of a connection.

In a first aspect of the embodiments of the present disclosure, a method for monitoring status of a connection is provided. The method includes sending, based on a received user request, a capture task of a data packet associated with the user request to multiple nodes. The method further includes receiving the captured data packet from the multiple nodes. The method further includes determining information of a source end of the data packet, information of a target end of the data packet, and operation information of a connection between the source end and the target end. The method further includes monitoring the status of the connection based on at least one of the data packet, the information of the source end, the information of the target end, and the operation information.

In a second aspect of the embodiments of the present disclosure, an electronic device is provided. The electronic device includes one or more processors, and a storage apparatus used to store one or more programs; when one or more programs are executed by the one or more processors, the one or more processors are enabled to implement a method for monitoring status of a connection. The method includes sending, based on a received user request, a capture task of a data packet associated with the user request to multiple nodes. The method further includes receiving the captured data packet from the multiple nodes. The method further includes determining information of a source end of the data packet, information of a target end of the data packet, and operation information of a connection between the source end and the target end. The method further includes monitoring the status of the connection based on at least one of the data packet, the information of the source end, the information of the target end, and the operation information.

In a third aspect of the embodiments of the present disclosure, a computer-readable storage medium is provided, on which a computer program is stored and the program, when executed by a processor, implements a method for monitoring status of a connection. The method includes sending, based on a received user request, a capture task of a data packet associated with the user request to multiple nodes. The method further includes receiving the captured data packet from the multiple nodes. The method further includes determining information of a source end of the data packet, information of a target end of the data packet, and operation information of a connection between the source end and the target end. The method further includes monitoring the status of the connection based on at least one of the data packet, the information of the source end, the information of the target end, and the operation information.

It should be understood that the content described in the Summary of the Invention section is neither intended to limit key or essential features of the embodiments of the present disclosure, nor intended to limit the scope of the present disclosure. Other features of the present disclosure will become readily understood from the following description.

### BRIEF DESCRIPTION OF THE DRAWINGS

The above-mentioned and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 shows a schematic diagram of an example environment in which multiple embodiments of the present disclosure can be implemented;

FIG. 2 shows a flowchart of a method for unloading compressed loads of a connection according to some embodiments of the present disclosure;

FIG. 3A shows a schematic diagram of an architecture of a tracking service for monitoring status of a connection according to some embodiments of the present disclosure;

FIG. 3B shows a schematic diagram of a connection among clients, services, and Pods in multiple nodes according to some embodiments of the present disclosure;

FIG. 3C shows a schematic diagram of a query table including information of Pods and services according to some embodiments of the present disclosure;

FIG. 3D shows a schematic diagram of an operation tracking table according to some embodiments of the present disclosure;

FIG. 4 shows a flowchart of a method for monitoring connection performances and fault diagnosis according to some embodiments of the present disclosure;

FIG. 5 shows a schematic diagram of a process of capturing a data packet according to some embodiments of the present disclosure;

FIG. 6 shows a schematic diagram of calculating an input/output (IO) delay value and throughput according to some embodiments of the present disclosure; and

FIG. 7 shows a block diagram of a device that can implement multiple embodiments of the present disclosure.

### DETAILED DESCRIPTION

The embodiments of the present disclosure will be described in more detail below with reference to the accompanying drawings. Although some embodiments of the present disclosure are illustrated in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are for illustrative purposes only, and are not intended to limit the scope of protection of the present disclosure.

In the description of embodiments of the present disclosure, the term “include” and similar terms thereof should be understood as open-ended inclusion, i.e., “including but not limited to.” The term “based on” should be understood as “based at least in part on.” The term “an embodiment” or “the embodiment” should be construed as “at least one embodiment.” The terms “first,” “second,” and the like may refer to different or the same objects. Other explicit and implicit definitions may also be included below.

As stated in the above text, although there are tools in existing technologies that can track a single connection of data packets between services, these tools are often limited to the perspective of a single connection. In a complex environment of a DD extended system, the connections between services often span multiple nodes and go through complex routing paths and proxies. Therefore, it is difficult to comprehensively capture the full picture of inter-service communication and provide sufficient intelligent diagnostic information for complex routing and proxy scenarios solely by tracking the data packets of a single connection.

Meanwhile, although there are tools in related technologies that can provide visualization of a system topology, these tools rely on macro indicators such as average delay and lack data support with finer granularity. For example, in a DD extended system, performance problems may arise from small delay differences or specific routing paths. Due to the lack of comprehensive data support, these tools cannot help system administrators more accurately locate root causes of problems and develop targeted optimization strategies.

Regarding this, embodiments of the present disclosure provide a solution for monitoring status of a connection. The method includes sending a capture task of a data packet associated with a user request to multiple nodes, determining information of a source end of the data packet, information of a target end of the data packet, and operation information of a connection between the source end and the target end after receiving the captured data packet, and finally monitoring the status of the connection according to the information. In this way, information of various communication endpoints and their connections within a node can be comprehensively captured, providing more detailed and accurate data, so as to more accurately identify the status of a connection, locate root causes of connection performance problems, and make targeted optimization strategies.

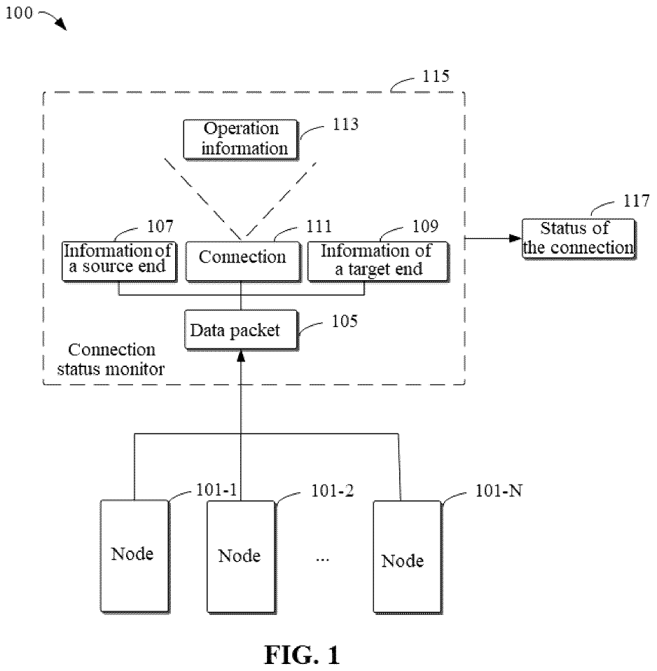

FIG. 1 shows a schematic diagram of an example environment 100 in which multiple embodiments of the present disclosure can be implemented. As shown in FIG. 1, the example environment 100 can include multiple nodes, for example, a node 101-1, a node 101-2, and a node 101-N. The nodes can be physical devices such as computers, servers, routers, etc., and can also be logical entities such as software processes, virtual machines, containers, etc. In some embodiments, the node 101-1, the node 101-2, and the node 101-N can be nodes in a DD extended system, nodes in other types of clusters, or nodes that do not belong to any cluster but act as an independent computing entity. The node 101-1, the node 101-2, and the node 101-N can be an independent entity that participates in system operation and has computing and communication capabilities.

In an embodiment of the present disclosure, a connection status monitor 115 accepts a user request. The connection status monitor 115 can be a module with computing and data processing capabilities, responsible for receiving requests from users. The user requests can include specific operations or tasks that users wish the system to perform, such as data queries, data updates, service calls, etc. In order to respond to a user request, the connection status monitor 115 can rely on computing units within a node to process the user request, and the processing process involves communication between clients, services within the node, and Pods within the node. To effectively monitor a process of processing the user requests by the system, the connection status monitor 115 can send a capture task of a data packet 105 associated with the user request to multiple nodes, i.e., capture the data packet 105 which needs to be transmitted between communication endpoints. The quantity of the data packet 105 can be one or multiple, which is determined by the quantity of computing units associated with the user request.

As shown in FIG. 1, when the connection status monitor 115 accepts the data packet 105, information 107 of the source end of the data packet 105 and information 109 of the target end of the data packet 105 can be determined according to information of the data packet 105 itself. The information 107 of the source end and the information 109 of the target end can be acquired from nodes after determining objects of the source end and the target end of the data packet 105. The information 107 of the source end can include an Internet Protocol (IP) address of the source end, a port number of the source end, whether it has been destroyed, and whether it needs to be rescheduled. The information 109 of the target end can include an IP address of the target end, a port number of the target end, whether it has been destroyed, and whether it needs to be rescheduled. The information 107 of the source end and the information 109 of the target end together form the basis for monitoring the status of the connection.

In some embodiments, after determining the information 107 of the source end and the information 109 of the target end, operation information 113 of a connection 111 between the source end and the target end can further be acquired from the node. The operation information 113 can include whether the connection 111 is interrupted, the sending time of the data packet 105, the response time of the data packet 105, whether a transmission of the data packet 105 is retried, and an IO data amount of the data packet 105. Therefore, the operation information 113 can serve as a benchmark for measuring the status of the connection 117 of the network.

In some embodiments, the connection status monitor 115 can monitor the connection status 117 based on a combination of one or more of the information of the data packet 105, the information 107 of the source end, the information 109 of the target end, and the operation information 113. The connection status 117 can include a health status, performance, and potential problems of network connections. For example, it can be determined whether the connection 111 is interrupted through the operation information 113. When the connection 111 is interrupted, it can be determined whether the interruption is caused by the destruction or rescheduling of the target end through the information 109 of the target end. For another example, if the connection status monitor 115 detects frequent retries in the data packet 105 based on the information of the data packet 105 and the operation information 113, then the network connection may be congested or unstable. At this time, the connection status monitor 115 can further combine the information of the source end and the information of the target end to comprehensively determine the root causes of the problems and take corresponding measures for optimization or repair.

In this way, information about various communication endpoints and their connections is comprehensively captured, providing more detailed and accurate data, so as to achieve comprehensive and precise monitoring of the network's connection status, locate root causes of connection performance problems, and provide strong guarantees for the stable operation of the system. Meanwhile, this monitoring method also has high flexibility and scalability, and can adapt to network environments of different scales and complexities.

It should be understood that description of the architecture and functions in the example environment 100 is made for illustrative purposes only and does not imply any limitation to the scope of the present disclosure. The embodiments of the present disclosure may also be applied to other environments having different structures and/or functions.

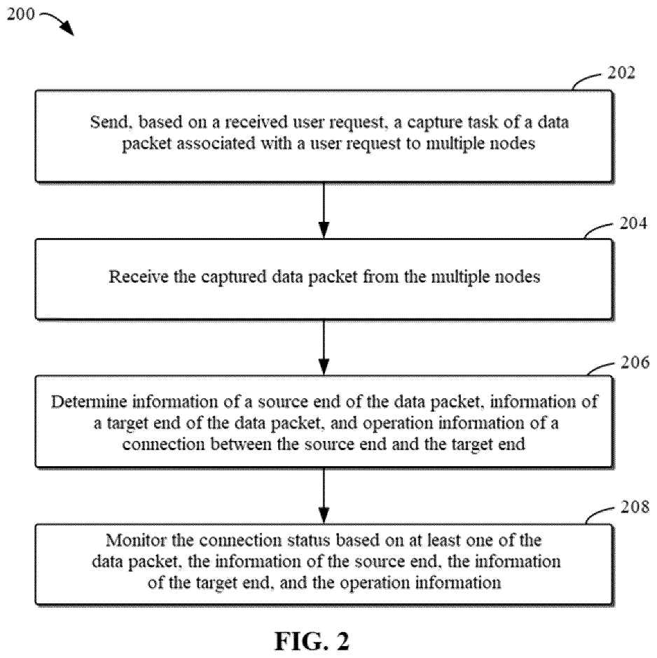

A process of the embodiment of the present disclosure will be described in detail below with reference to FIG. 2 to FIG. 7. For ease of understanding, the specific data referred to in the following description is all illustrative and is not intended to limit the scope of protection of the present disclosure. It should be understood that the embodiments described below may also include additional actions not shown and/or may omit actions shown, and the scope of the present disclosure is not limited in this regard.

FIG. 2 shows a flowchart of a method 200 for unloading compression loads according to some embodiments of the present disclosure. The method 200 can be executed by a connection status monitor in an electronic device, and the method 200 includes a block 202, a block 404, a block 206, and a block 208. At the block 202, based on a received user request, a capture task of a data packet associated with a user request is sent to multiple nodes. For example, as shown in FIG. 1, the connection status monitor 115 can send, based on the user request, a capture task of a data packet 105 associated with the user request to multiple nodes, that is, capture the data packet 105 that needs to be transmitted between the communication endpoints. The quantity of the data packet 105 can be one or multiple, which is determined by the quantity of computing units associated with the user request.

At the block 204, the captured data packet is received from multiple nodes. For example, as shown in FIG. 1, when the multiple nodes received the capture task, connections between multiple services or Pods within a node can be tracked in real time so as to capture the data packet 105 associated with the user request, and then the captured data packet 105 are sent to the connection status monitor 115.

At the block 206, information of the source end of the data packet, information of the target end of the data packet, and operation information of a connection between the source end and the target end are determined. For example, as shown in FIG. 1, when the connection status monitor 115 accepts the data packet 105, information 107 of the source end of the data packet 105 and information 109 of the target end of the data packet 105 can be determined based on the information of the data packet 105 itself. For example, the IP addresses of the source end and the target end can be determined by identifying a connection to which the data packet 105 belongs, thereby determining the information 107 of the source end and the information 109 of the target end. The information 107 of the source end can include an IP address of the source end, a port number of the source end, whether it has been destroyed, and whether it needs to be rescheduled. The information 109 of the target end can include an IP address of the target end, a port number of the target end, whether it has been destroyed, and whether it needs to be rescheduled. The information 107 of the source end and the information 109 of the target end together form the basis for monitoring the status of the connection.

In some embodiments, after determining the information 107 of the source end and the information 109 of the target end, operation information 113 of a connection 111 between the source end and the target end can further be acquired from the node. The operation information 113 can include whether the connection 111 is interrupted, the sending time of the data packet 105, the response time of the data packet 105, whether a transmission of the data packet 105 is retried, and an IO data amount of the data packet 105. Therefore, the operation information 113 can serve as a benchmark for measuring the status of the connection 117 of the network.

At the block 208, the status of the connection is monitored based on at least one of the data packet, the information of the source end, the information of the target end, and the operation information. For example, as shown in FIG. 1, the connection status monitor 115 can monitor the connection status 117 based on a combination of one or more of the information of the data packet 105, the information 107 of the source end, the information 109 of the target end, and the operation information 113. For example, it can be determined whether the connection 111 is interrupted through the operation information 113. When the connection 111 is interrupted, it can be determined whether the interruption is caused by the destruction or rescheduling of the target end through the information 109 of the target end. For another example, if the connection status monitor 115 detects frequent retries in the data packet 105 based on the information of the data packet 105 and the operation information 113, then the network connection may be congested or unstable. At this time, the connection status monitor 115 can further combine the information of the source end and the information of the target end to comprehensively determine the root causes of the problems and take corresponding measures for optimization or repair.

In this way, information about various communication endpoints and their connections is comprehensively captured, providing more detailed and accurate data, so as to achieve comprehensive and precise monitoring of the network's connection status, locate root causes of connection performance problems, and provide strong guarantees for the stable operation of the system. Meanwhile, this monitoring method also has high flexibility and scalability, and can adapt to network environments of different scales and complexities.

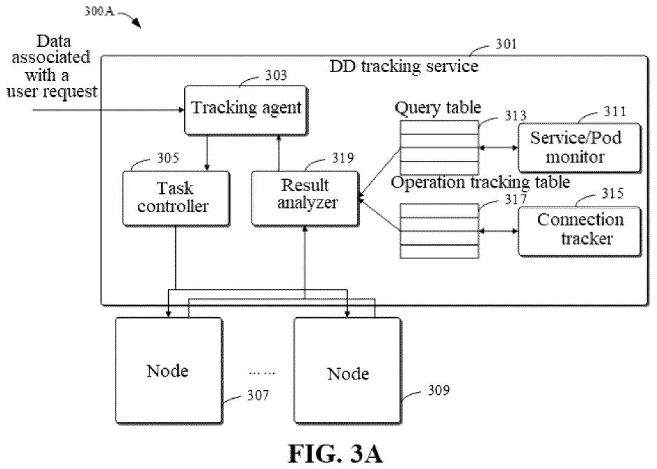

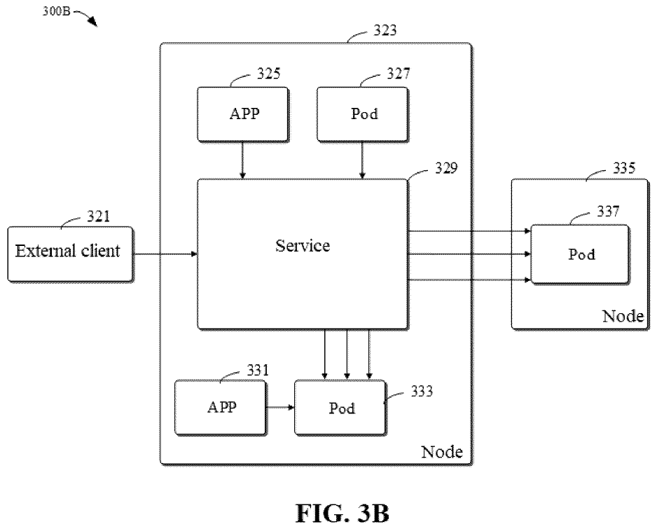

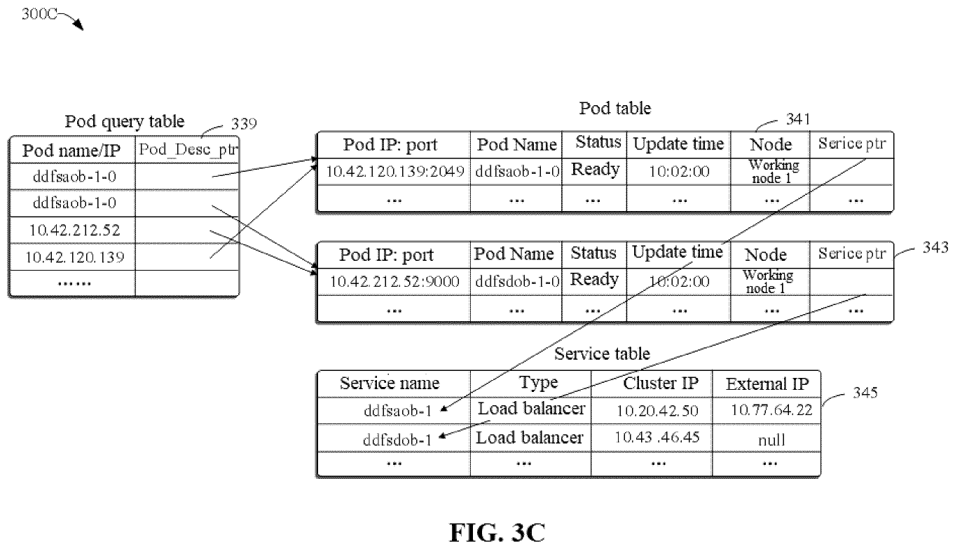

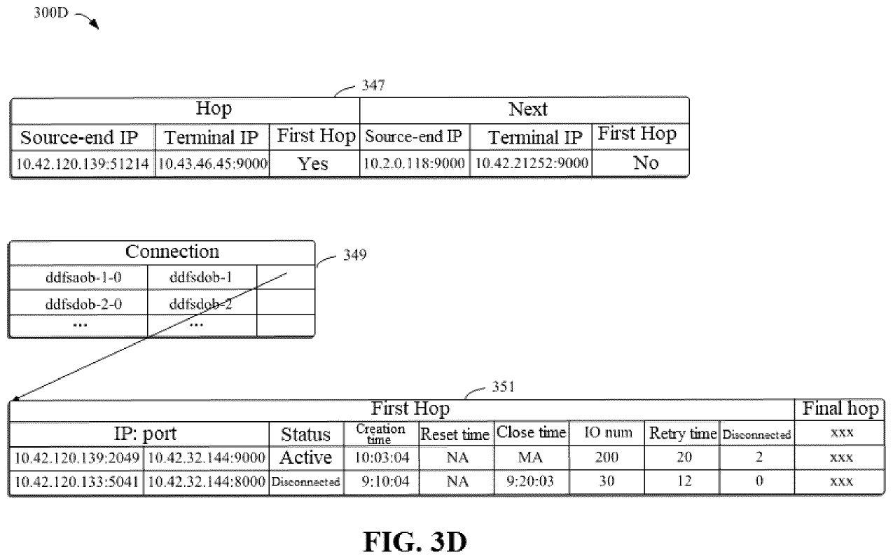

An example process of scheduling resources will be described below in detail with reference to FIG. 3 to FIG. 7. In an embodiment of the present disclosure, an architecture of a tracking service used to monitor status of a connection, a type of the connection, creating a query table, creating an operation tracking table, a method for monitoring the connection performance and fault diagnosis, a process of capturing a data packet, and calculation of an IP delay value and throughput are explained in sequence. The specific data mentioned in the following text is exemplary and is not intended to limit the protection scope of the present disclosure. It should be understood that the embodiments described below may also include additional actions not shown and/or may omit actions shown, and the scope of the present disclosure is not limited in this regard.

FIG. 3A shows a schematic diagram of an architecture 300A of a tracking service for monitoring status of a connection according to some embodiments of the present disclosure. As shown in FIG. 3A, the status of the connection is monitored by a DD tracking service 301. In an embodiment of the present disclosure, the DD tracking service 301 can be used to monitor the status of the connection of services and/or Pods in a DD extended system. Certainly, the architecture of the DD tracking service 301 can also be applied to other systems or clusters, which is not limited in the present disclosure. The function of the DD tracking service 301 is consistent with that of the connection status monitor 115 in FIG. 1. Functions of a node 307 and a node 309 are consistent with those of the node 101-1, the node 101-2, and the node 101-N in FIG. 1, which is not described herein again.

In some embodiments, the DD tracking service 301 can include a tracking agent 303 used for accepting data associated with a user request to determine a data packet associated with the user request. Then, the tracking agent 303 sends information of the data packet that needs to be captured to a task controller 305. The task controller 305 can load a data packet capture task on multiple nodes based on the extended Berkeley Packet Filter (eBPF) technology. After the multiple nodes capture the data packet, a result analyzer 319 can receive the data packet.

In some embodiments, a service/Pod monitor can acquire information from multiple nodes regarding multiple services and Pods before processing the user request, create a query table 313 according to the information of multiple services and Pods, and update the query table 313 every preset time (also referred to as first preset time). A connection tracker 315 can also determine the connection associated with the user request, and then acquire operation information of the connection from a node to construct an operation tracking table 317. The operation tracking table 317 can also be updated every preset time (also referred to as second preset time). In an embodiment of the present disclosure, the query table 313 can include multiple services and an IP address of a Pod, a port number of the Pod, whether it has been destroyed, and whether it needs to be rescheduled. The operation tracking table 317 can include whether the connection is interrupted, the sending time of the data packet, the response time of the data packet, whether a transmission of the data packet is retried, and an IO data amount of the data packet.

In some embodiments, the result analyzer 319 can monitor and analyze the status of the connection based on the information of the captured data packet, the query table 313, and the operation tracking table 317. For example, after accepting the data packet, the result analyzer 319 can determine a connection corresponding to the data packet, then inquire the operation tracking table 317 to acquire the operation information of the connection, a source end address and a target end address of the connection, and finally inquire the information of the source end and the information of the target end in the query table 313 according to the source end address and the target end address, so as to realize status monitoring. After completing status monitoring and fault diagnosis, the result analyzer 319 may return an analysis result to the tracking agent 303.

FIG. 3B shows a schematic diagram of a connection 300B among clients, services, and Pods in multiple nodes according to some embodiments of the present disclosure. As shown in FIG. 3B, functions of a node 323 and a node 335 are consistent with those of the node 101-1, the node 101-2, and the node 101-N in FIG. 1, which is not described herein again. An external client 321, a node 323, and a node 335 can communicate with each other to respond to the user request. In some embodiments, the node 323 includes an application (APP) 325, a Pod 327, a service 329, an APP 331, and a Pod 333. The node 335 includes a Pod 337. The App, the service, and the Pod in the node 323 can communicate with each other. A communication link can be the APP 331-the service 329-the Pod 327, or the Pod 333-the Pod 327, or the service 329-the Pod 333. The communication endpoint in the node 323 can also communicate with the communication endpoint in the node 323. For example, the communication link can be the service 329-the Pod 327. There are various communication links, which is not limited in the present disclosure.

As stated above, due to the inclusion of multi-hop in the connection and diverse forwarding paths, it is difficult to track every hop. Tracking each hop also means adding more tracking points in the eBPF program. This may affect system performance, generate a large amount of tracking data, and increase computational complexity. Therefore, only the connection between a first hop and a final hop can be tracked, for example, the first hop can be a client and the final hop can be a terminal. This can be achieved through the connection tracking (conntrack) supported by the operating system. In this way, the connection tracker 315 in FIG. 3A can only track the specified hop in the connection and create the operation tracking table 317 based on the operation information of the specified hop. By means of the operation tracking table 317, the connection can be quickly identified and the address information of the client, service, and Pod can be obtained for performance calculation.

FIG. 3C shows a schematic diagram of a query table 300C including information of Pods and services according to some embodiments of the present disclosure. As shown in FIG. 3C, the query table can include a Pod query table 339, and the Pod query table 339 is indexed by the name of the Pod, and the corresponding Pod table can be queried by the Pod name, such as a Pod table 341 or a Pod table 343. The quantity of Pod tables is determined by the quantity of Pods in multiple nodes. The Pod table can contain information such as a Pod name, an IP address, status, update time, a node and a service name, etc. Among them, the service name can be used as an index to export a service table 345. The service table 345 can include information such as a service name, a type, a port, a target Pod, and status. By combining the Pod query table 339 and the service table 345, it is possible to efficiently query and manage Pods and services in the cluster.

FIG. 3D shows a schematic diagram of an operation tracking table 300D according to some embodiments of the present disclosure. As shown in FIG. 3D, the operation tracking table can include a table 347, a table 349, and a table 351. The table 347 includes the source end IP address and terminal IP address of the hops that need to be tracked in the connection. The table 347 can be used to determine the source end IP address and terminal IP address of the connection corresponding to the data packet. The table 349 includes the names of connections, which can serve as an index to the table 351. The table 351 can include each piece of detailed operational information for each connection, such as an IP port, status, setup time, reset time, shutdown time, an IO data amount, retry time, etc. In some embodiments, in order to achieve fast queries, the above tables can be implemented using hash tables.

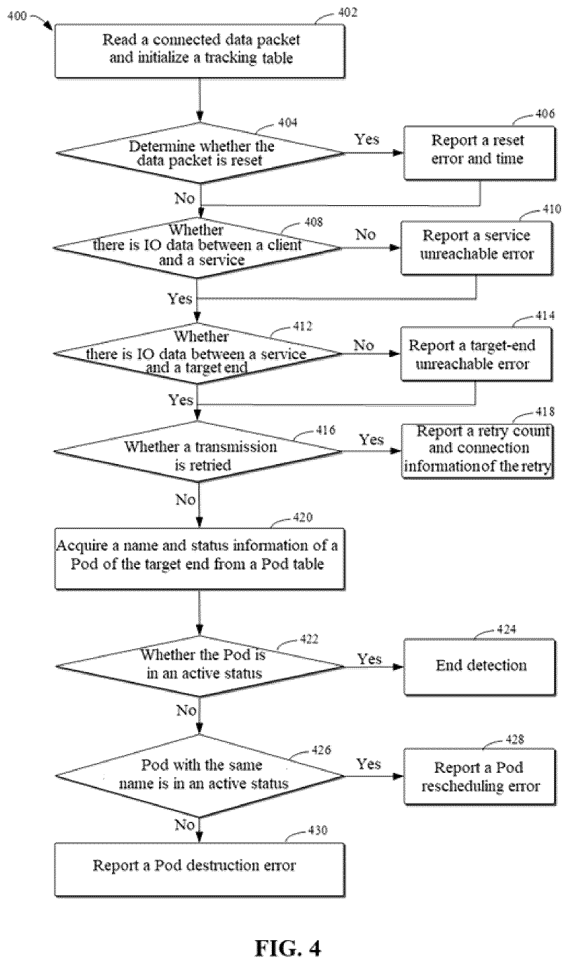

FIG. 4 shows a flowchart of a method 400 for monitoring connection performances and fault diagnosis according to some embodiments of the present disclosure. In the method 400, an example in which a source end of a data packet is used as a client and a Pod as a terminal is used for explaining and describing connection performance monitoring and fault diagnosis. At a block 402, the data packet on the connection is read and the tracking table is initialized. For example, as shown in FIG. 3A, the task controller 305 can send a capture task of the data packet to multiple nodes based on the user request, the service/Pod monitor 311 initializes the query table 313, and the connection tracker initializes the operation tracking table 317. At a block 404, it is determined whether the data packet is reset. For example, as shown in FIG. 3A, the result analyzer 319 can determine, according to the information of the received data packet, whether the data packet is reset. When it is detected that the data packet is reset, a block 406 is executed, and a reset error and time are reported. The result analyzer 319 can report the reset error and reset time to the tracking agent 303.

At a block 408, it is determined whether there is IO data between the client and the service. For example, as shown in FIG. 3A, the result analyzer 319 can query the operation tracking table 317 to determine whether there is IO data between the client and the service. When there is no IO data between the client and the service, a block 410 is executed, and a service unreachable error is reported. The result analyzer 319 can report the service unreachable error to the tracking agent 303. At a block 412, it is determined whether there is IO data between the service and the target end. For example, as shown in FIG. 3A, when the target end is a Pod, the result analyzer 319 can query the operation tracking table 317 to determine whether there is IO data between the service and the Pod. When there is no IO data between the service and the Pod, a block 414 is executed, and a Pod unreachable error is reported. The result analyzer 319 can report the Pod unreachable error to the tracking agent 303.

At a block 416, it is determined whether a transmission is retried. For example, as shown in FIG. 3A, the result analyzer 319 can query the operation tracking table 317 to determine whether the transmission of the data packet is retried. When the transmission is retried, a block 418 is executed, and a retry count and connection information of the retries are reported. When the transmission is not retried, it means that the transmission of the data packet may have failed, a block 420 is executed at this time, and a name and status information of the Pod are acquired from a Pod table. For example, as shown in FIGS. 3A and 3C, the result analyzer 319 can query the Pod table in the operation tracking table 317 to acquire the name and status information of the Pod of the target end.

At a block 422, it is determined whether the Pod is in an active status. The result analyzer 319 can determine, according to the acquired Pod status information, whether the Pod is in an active status. When the Pod is in an active status, a block 424 is executed, and the detection ends. When the Pod is not in an active status, a block 426 is executed, and it is determined whether another Pod with the same name is in an active status. When the another Pod is in an active status, a block 428 is executed, and a Pod rescheduling error is reported. Otherwise, a block 430 is executed, and a Pod destruction error is reported.

In this way, information of each data packet can be captured, which helps locate the root causes of problems when they exist, enabling tracking services to provide more accurate and comprehensive performance data to assist in performance tuning and fault diagnosis.

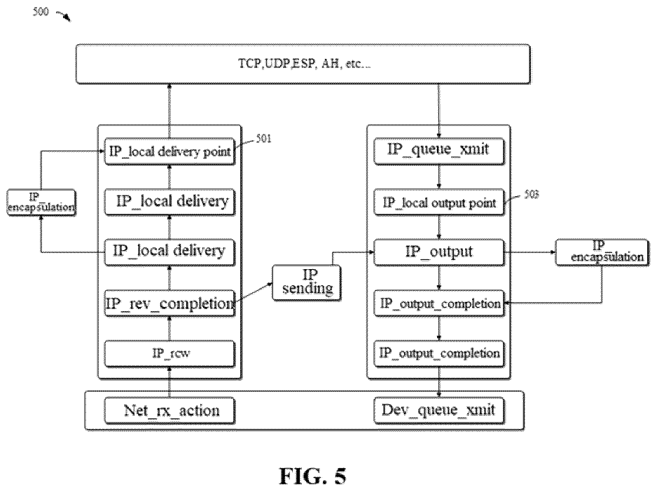

FIG. 5 shows a schematic diagram of a process 500 of capturing a data packet according to some embodiments of the present disclosure. FIG. 5 shows a process of processing and forwarding the data packet in an IP layer. For each received data packet, the IP layer needs to perform data unpacking/packaging or forwarding. To more accurately calculate the delay of the data packet from an upper layer, a local delivery point 501 and a local output point 503 can be used as tracking points. The local delivery point 501 and the local output point 503 are located near a TCP layer and contain a complete data packet from the upper layer without unpacking/packaging. By means of these two tracking points, it is easy to calculate the IO delay value and throughput, while avoiding generating a large amount of tracking data. In this way, it can help to track throughput and delay in both inlet and outlet directions more accurately with lower system performance impact and fewer tracking logs in the extended system, so as to meet the requirements of fine performance tuning in the DD extended system.

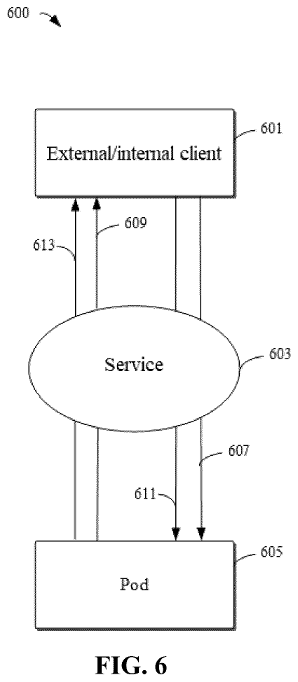

FIG. 6 shows a schematic diagram of calculating an input/output (IO) delay value and throughput 600 according to some embodiments of the present disclosure. In a DD cluster system, IO delay value and throughput are very important indicators for performance tuning. An example in which a data packet communication link is an external/internal client 601-a service 603-a Pod 605 is taken for explanation. At 607, the data packet is sent by the external/internal client 601 to the Pod 605, indicating inlet sending. Relatively, at 609, the data packet is returned by the Pod 605 to the external/internal client 601, indicating an inlet response. At 611, the data packet is sent by the external/internal client 601 to the Pod 605, indicating outlet sending. Relatively, at 609, the data packet is returned by the Pod 605 to the external/internal client 601, indicating an outlet response.

In some embodiments, an IO delay value of the data packet inlet can be obtained by subtracting the inlet response time of the data packet returning from the Pod 605 to the external/internal client 601 from the inlet sending time of the data packet sending from the external/internal client 601 to the Pod 605. Relatively, an IO delay value of the data packet outlet can be obtained by subtracting the outlet response time of the data packet returning from the Pod 605 to the external/internal client 601 from the outlet sending time of the data packet sending from the external/internal client 601 to the Pod 605.

In some embodiments, the entropy of the data amount of the data packet and the difference obtained by subtracting the time of first data reception of the source end from the latest response time of the source end can be used as the input throughput. For example, a difference can be obtained by subtracting the time of first data reception of the external/internal client 601 from the latest response time of the external/internal client 601, and then the entropy between the data amount of the data packet and the difference is calculated to obtained the input throughput. Relatively, the entropy of the data amount of the data packet and the difference obtained by subtracting the time of first data reception of the target end from the latest response time of the target end is used as the output throughput. For example, a difference can be obtained by subtracting the time of first data reception of the Pod 605 from the latest response time of the Pod 605, and then the entropy between the data amount of the data packet and the difference is calculated to obtain the input throughput.

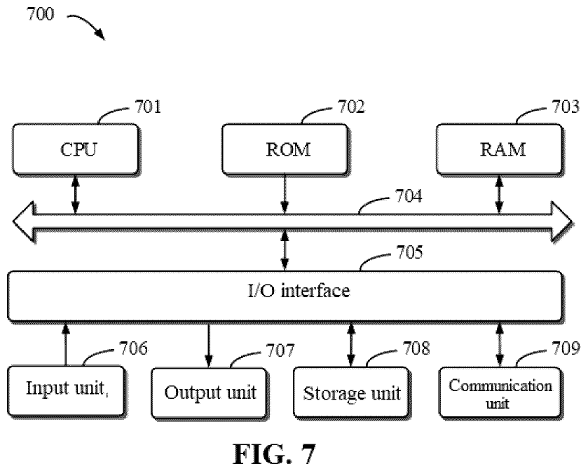

FIG. 7 shows a schematic block diagram of an example device 700 that can be used to implement the embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to an I/O interface 705, including: an input unit 706, such as a keyboard and a mouse; an output unit 707, such as various types of displays and speakers; the storage unit 708, such as a magnetic disk and an optical disk; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described in the text above can be performed at least in part by one or more hardware logic components. For example, non-restrictively, demonstration types of hardware logic components that can be used include Field Programmable Gate Arrays (FPGAs), Application Specific Integrated Circuits (ASICs), Application Specific Standard Parts (ASSPs), Systems On Chip (SOC), Complex Programmable Logic Devices (CPLDs), etc.

Program codes for implementing the method of the present disclosure may be written by using one programming language or any combination of multiple programming languages. The program codes may be provided to a processor or controller of a general purpose computer, a special purpose computer, or another programmable data processing apparatus, such that the program codes, when executed by the processor or controller, cause the functions/operations specified in the flow charts and/or block diagrams to be implemented. The program codes may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. In certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. In contrast, various features that are described in the context of a single implementation may also be implemented in multiple implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

1. A method for monitoring status of a connection, comprising:
sending, based on a received user request, a capture task of a data packet associated with the user request to multiple nodes;
receiving the captured data packet from the multiple nodes;
determining information of a source end of the data packet, information of a target end of the data packet, and operation information of a connection between the source end and the target end; and
monitoring the status of the connection based on at least one of the data packet, the information of the source end, the information of the target end, and the operation information.

2. The method according to claim 1, further comprising:
updating, based on first preset time, a query table comprising information of multiple services of the multiple nodes and information of multiple groups of pods (Pod).

3. The method according to claim 2, wherein determining information of a source end of the data packet, information of a target end of the data packet, and operation information of a connection between the source end and the target end comprises:
acquiring, based on the user request, a source address, a target address, and the operation information of the connection associated with the user request;
creating an operation tracking table based on the source address, the target address, and the operation information;
in response to receiving the data packet, determining a source address, a target address, and operation information of a connection corresponding to the data packet in the operation tracking table; and
determining, based on the determined source address, the determined target address, and the query table, information of the source end of the data packet and information of the target end of the data packet.

4. The method according to claim 3, wherein the connection comprises a multi-hop, and acquiring a source address, a target address, and operation information of a connection associated with the user request comprises:
acquiring source addresses, target addresses, and operation information of a first hop and a final hop of the connection.

5. The method according to claim 4, further comprising:
updating the operation tracking table based on second preset time.

6. The method according to claim 1, wherein monitoring the status of the connection comprises:
determining whether the data packet is a reset data packet; and
in response to that the data packet is the reset data packet, reporting a reset error and reset time.

7. The method according to claim 6, wherein monitoring the status of the connection further comprises:
determining, based on the operation information, whether the connection comprises input/output (IO) data; and
in response to that the connection does not comprise the IO data, reporting that the target end is

8. The method according to claim 7, wherein monitoring the status of the connection further comprises:
determining, based on the operation information, whether transmission of the data packet is retried; and
in response to that the transmission of the data packet is retried, reporting the number of retries and information of a connection corresponding to the data packet.

9. The method according to claim 8, wherein monitoring the status of the connection further comprises:
in response to that the transmission of the data packet is not retried, determining whether a Pod of the target end is in an active status; and
in response to that the Pod of the target end is in an active status, completing monitoring.

10. The method according to claim 9, wherein monitoring the status of the connection further comprises:
in response to that the Pod of the target end is not in an active status, determining whether another Pod with the same name as the Pod is in an active status;
in response to that another Pod with the same name as the Pod is in an active status, reporting a Pod rescheduling error; and
in response to that another Pod with the same name as the Pod is not in an active status, reporting a Pod destruction error.

11. The method according to claim 1, wherein monitoring the status of the connection comprises:
determining an IO delay value of the data packet based on a sending duration of sending the data packet from the source end to the target end and a response duration of returning the data packet from the target end to the source end.

12. The method according to claim 11, wherein monitoring the status of the connection further comprises:
determining an input throughput based on a data amount of the data packet, latest response time of the source end, and time of first data reception of the source end; and
determining an output throughput based on a data amount of the data packet, latest response time of the target end, and time of first data reception of the target end.

13. The method according to claim 1, wherein the data packet is captured by the multiple nodes from local delivery points and local output points in an internet protocol (IP) layer.

14. An electronic device, comprising:
at least one processor; and
a memory coupled to the at least one processor and having instructions stored therein, wherein the instructions, when executed by the at least one processor, cause the electronic device to perform following operations:
sending, based on a received user request, a capture task of a data packet associated with the user request to multiple nodes;
receiving the captured data packet from the multiple nodes;
determining information of a source end of the data packet, information of a target end of the data packet, and operation information of a connection between the source end and the target end; and
monitoring the status of the connection based on at least one of the data packet, the information of the source end, the information of the target end, and the operation information.

15. The device according to claim 14, wherein the operations further comprise:
updating, based on first preset time, a query table comprising information of multiple services of the multiple nodes and information of multiple groups of pods (Pod).

16. The device according to claim 15, wherein determining information of a source end of the data packet, information of a target end of the data packet, and operation information of a connection between the source end and the target end comprises:
acquiring, based on the user request, a source address, a target address, and the operation information of the connection associated with the user request;
creating an operation tracking table based on the source address, the target address, and the operation information;
in response to receiving the data packet, determining a source address, a target address, and operation information of a connection corresponding to the data packet in the operation tracking table; and
determining, based on the determined source address, the determined target address, and the query table, information of the source end of the data packet and information of the target end of the data packet.

17. The device according to claim 16, wherein the connection comprises a multi-hop, and an instruction for acquiring a source address, a target address, and operation information of a connection associated with the user request comprises:
acquiring source addresses, target addresses, and operation information of a first hop and a final hop of the connection.

18. The device according to claim 17, wherein the operations further comprise:
updating the operation tracking table based on second preset time.

19. The device according to claim 14 wherein the operations further comprise:
determining whether the data packet is a reset data packet; and
in response to that the data packet is the reset data packet, reporting a reset error and reset time.

20. A computer program product, the computer program product being tangibly stored on a non-volatile computer-readable medium and comprising machine-executable instructions, wherein the machine-executable instructions, when executed by a machine, cause the machine to perform following operations:
sending, based on a received user request, a capture task of a data packet associated with the user request to multiple nodes;
receiving the captured data packet from the multiple nodes;
determining information of a source end of the data packet, information of a target end of the data packet, and operation information of a connection between the source end and the target end; and
monitoring the status of the connection based on at least one of the data packet, the information of the source end, the information of the target end, and the operation information.
